(19) United States
(12) Patent Application Publication
(10) Pub. No.: US 2014/0324769 A1
(43) Pub. Date: Oct. 30, 2014

(54) DOCUMENT DRIVEN METHODS OF MANAGING THE CONTENT OF DATABASES THAT CONTAIN INFORMATION RELATING TO SEMICONDUCTOR MANUFACTURING OPERATIONS

(71) Applicant: GLOBALFOUNDRIES INC., Grand Cayman (KY)

(72) Inventors: Stephan Puelm, Dresden (DE); Roy Boerner, Dresden (DE); Alexander Kroll, Meissen (DE); Uwe Heber, Goppeln (DE); Thomas Kretschmer, Dresden (DE); Hardy Schumacher, Schwarzheide (DE); Uwe Mende-Preusser, Kreischa (DE); Gert Poeschel, Tharandt (DE)

(73) Assignee: GLOBALFOUNDRIES Inc., Grand Cayman (KR)

(21) Appl. No.: 13/870,273

(22) Filed: Apr. 25, 2013

(51) Int. Cl. G06F 17/30

(52) U.S. Cl. CPC G06F 17/30011
USPC 707/608

(57) ABSTRACT

One illustrative method disclosed herein includes storing a semiconductor manufacturing document in a document management system, wherein the semiconductor manufacturing document comprises semiconductor manufacturing data, and actuating an extractor tool to extract at least a portion of the semiconductor manufacturing data from the semiconductor manufacturing document and transfer the extracted semiconductor manufacturing data to at least one table in the semiconductor manufacturing database.

### BACKGROUND OF THE INVENTION

1. Field of the Invention

The present disclosure generally relates to the fabrication of integrated circuits, and, more particularly, to various document driven methods of managing the content of databases that contain information related to semiconductor manufacturing operations.

2. Description of the Related Art

In modern integrated circuits, such as microprocessors, storage devices and the like, a very large number of circuit elements, especially transistors, are provided and operated on a restricted chip area. Immense progress has been made over recent decades with respect to increased performance and reduced feature sizes of circuit elements, such as transistors. However, the ongoing demand for enhanced functionality of electronic devices forces semiconductor manufacturers to steadily reduce the dimensions of the circuit elements and to increase the operating speed of the circuit elements. The continuing scaling of feature sizes, however, involves great efforts in redesigning process techniques and developing new process strategies and tools so as to comply with new design rules. Generally, in complex circuitry including complex logic portions, MOS technology is presently a preferred manufacturing technique in view of device performance and/or power consumption and/or cost efficiency. In integrated circuits including logic portions fabricated by MOS technology, field effect transistors (FETs) are provided that are typically operated in a switched mode, that is, these devices exhibit a highly conductive state (on-state) and a high impedance state (off-state). The state of the field effect transistor is controlled by a gate electrode, which controls, upon application of an appropriate control voltage, the conductivity of a channel region formed between a drain region and a source region.

Manufacturing integrated circuit products requires performing numerous process operations in a very precise manner. In general, the formation of integrated circuit products involves performing a detailed sequence, i.e., a detailed process flow, of many different process operations, such as, for example, deposition processes, etching processes, ion implantation processes, chemical mechanical polishing (CMP) processes, photolithography processes, heating processes, etc., to manufacture the device. Such process operations are performed, more or less, on a layer-by-layer basis until the device is completed. Each of the process operations must be performed very precisely, i.e., within very tight processing windows (or tolerances), in order to produce a working device. Typically, a fabrication facility includes a plurality of process tools directed to each major processing operation. That is, a typical semiconductor manufacturing facility will contain a number of etch tools, a number of deposition tools, a number of CMP tools, etc. Moreover, within each type of processing operation, the number of tools adapted to perform such operations, e.g., a plurality of etching tools, may be made by different manufacturers, may be different models even if from the same manufacturer, etc. Thus, semiconductor manufacturers tend to treat each individual process tool separately, even though they perform the same basic type of processing operation, so as to account for any tool-to-tool variations in processing characteristics or capabilities.

Each processing tool, such as an etch tool, performs a process operation, e.g., etching a trench in a substrate, in accordance with a specific set of operational parameters, i.e., a specific process recipe. The process recipe contains process parameters such as, for example, temperature, gas flow compositions, gas flow rates, duration, etc. Of course, the particular process parameters vary depending upon the type of process tool under consideration, e.g., a polishing tool would have a different set of applicable process parameters. Moreover, even in the case of two or more tools adapted to do the same type of process, e.g., etching, the process recipes may be different for each tool due to inherent processing variations in each tool. For example, identical etching tools may use different processing parameters, e.g., the etch process may be performed at a slightly lower temperature in the first etch tool as compared to the second etch tool, in an effort to compensate for inherent variations between the two etch tools when they are used to perform the same basic etching process, such as forming a trench in a substrate.

Accordingly, semiconductor manufacturing operations involve the storage of a large amount of highly valuable and important data, such as the process recipes used by each process tool to perform a particular process operation. Additionally, the number of process operations performed increases the amount of data to be stored. For example, the process recipe used by etch tool “A” to form a trench in a semiconductor substrate will be different than the process recipe used by etch tool “A” to etch a trench in a layer of insulating material. This type of information, e.g., process recipes, is one example of semiconductor manufacturing data that semiconductor manufacturers routinely keep and track to insure that they can accurately and repeatedly make the integrated circuit products at issue.

The importance of keeping track of and insuring the accuracy of such semiconductor manufacturing data cannot be overstated. Typically, this type of data is stored in one or more databases that are typically accessed by a specifically tailored graphical user interface (GUI). For example, the database may contain a table of data, e.g., a etch process recipe, that needs to be populated for each unique process recipe. Examples of data that may be contained within the process recipe include a unique designation of the etching tool, e.g., etch tool number 101, a description of the basic process, e.g., trench etch—substrate, temperature, pressure, duration, etchant gases, etc. The GUI that is generated to input this information into the database typically creates the format in which the data will be input. The GUI may also be configured so as to limit access to such data. For example, the GUI may require the use of a log-in identification to access the data, may specify which type of rights a user has, e.g., read-only access, the right to change or edit the data, the right to approve any changes to the data, etc. The construction of such GUIs is a time-consuming and detailed process that must be undertaken for each unique type of process operation, e.g., the GUI used for inputting data for etching processes and tools is different from the GUI that is used for inputting data for the polishing processes and polishing tools. Creating these specifically tailored GUIs for each unique activity is a very time-consuming process and reflects a significant cost as it relates to software development. Moreover, inputting data into the semiconductor manufacturing database using such GUIs is a very time-consuming process that poses a significant chance for errors to be input. That is, if data has to be entered into a database from different systems, a user has to use a unique GUI for each system from which data is obtained. Thus, when data is input, another person typically double-checks the entered data, because the input of erroneous data can lead to very costly mistakes that may proceed for some time before the errors are recognized.

Another problem with currently employed methods is that, typically, only the most recent version of the semiconductor manufacturing data is contained in the database. That is, prior versions of the data, e.g., prior versions of process recipes used for a particular process on a particular tool, are not maintained in the accessible database. To the extent such prior versions are maintained, they are typically stored in a separate database or warehouse that usually must be separately accessed to see the revision history. Sometimes access to such historical versioning information is very important, e.g., when approving proposed changes to an existing process recipe.

Often reports are generated that are based upon the data contained in the semiconductor manufacturing database. The reports are generated by the database system using reporting frameworks in a human-readable form. In parallel to the data maintenance via the use of unique GUIs, semiconductor manufacturers must document and maintain various specifications regarding the processes they run and the products that they create. Such documentation enables semiconductor manufacturers to provide comprehensive product and process documentation to customers and/or engineers. Typically, these documents are stored in a separate document management system (DMS) for audit purposes and so as to have historical information of various revisions to the semiconductor manufacturing data in the semiconductor manufacturing database.

The present disclosure is directed to various document driven methods of managing the content of databases that contain information related to semiconductor manufacturing operations that may avoid, or at least reduce, the effects of one or more of the problems identified above.

### SUMMARY OF THE INVENTION

The following presents a simplified summary of the invention in order to provide a basic understanding of some aspects of the invention. This summary is not an exhaustive overview of the invention. It is not intended to identify key or critical elements of the invention or to delineate the scope of the invention. Its sole purpose is to present some concepts in a simplified form as a prelude to the more detailed description that is discussed later.

Generally, the present disclosure is directed to various document driven methods of managing the content of databases that contain information related to semiconductor manufacturing operations. One illustrative method disclosed herein includes storing a semiconductor manufacturing document in a document management system, wherein the semiconductor manufacturing document comprises semiconductor manufacturing data, and actuating an extractor tool to extract at least a portion of the semiconductor manufacturing data from the semiconductor manufacturing document and transfer the extracted semiconductor manufacturing data to at least one table in the semiconductor manufacturing database.

A further illustrative method disclosed herein includes storing a semiconductor manufacturing document in a document management system, wherein the semiconductor manufacturing document comprises semiconductor manufacturing data, using the document management system to obtain a final approval for the semiconductor manufacturing document and, after obtaining the final approval, actuating an extractor tool to extract at least a portion of the semiconductor manufacturing data from the semiconductor manufacturing document and transfer the extracted semiconductor manufacturing data to at least one table in the semiconductor manufacturing database.

Yet another illustrative method disclosed herein includes storing a plurality of semiconductor manufacturing documents in a document management system, each of the semiconductor manufacturing documents comprising semiconductor manufacturing data, conducting a polling operation of the plurality of semiconductor manufacturing documents located within the document management system, determining if a change has been made to any of the semiconductor manufacturing data on any of the plurality of semiconductor manufacturing documents and, upon detecting a change to the semiconductor manufacturing data in at least one of the plurality of semiconductor manufacturing documents, actuating an extractor tool to extract at least a portion of the semiconductor manufacturing data from the semiconductor manufacturing document where said semiconductor manufacturing data has been changed and transfer at least the extracted semiconductor manufacturing data to at least one table in a semiconductor manufacturing database.

### BRIEF DESCRIPTION OF THE DRAWINGS

The disclosure may be understood by reference to the following description taken in conjunction with the accompanying drawings, in which like reference numerals identify like elements, and in which:

FIGS. 1A-1C depict various methods disclosed herein for managing the content of databases that contain information related to semiconductor manufacturing operations.

While the subject matter disclosed herein is susceptible to various modifications and alternative forms, specific embodiments thereof have been shown by way of example in the drawings and are herein described in detail. It should be understood, however, that the description herein of specific embodiments is not intended to limit the invention to the particular forms disclosed, but on the contrary, the intention is to cover all modifications, equivalents, and alternatives falling within the spirit and scope of the invention as defined by the appended claims.

### DETAILED DESCRIPTION

Various illustrative embodiments of the invention are described below. In the interest of clarity, not all features of an actual implementation are described in this specification. It will of course be appreciated that in the development of any such actual embodiment, numerous implementation-specific decisions must be made to achieve the developers' specific goals, such as compliance with system-related and business-related constraints, which will vary from one implementation to another. Moreover, it will be appreciated that such a development effort might be complex and time-consuming, but would nevertheless be a routine undertaking for those of ordinary skill in the art having the benefit of this disclosure.

The present subject matter will now be described with reference to the attached figures. Various structures, systems and devices are schematically depicted in the drawings for purposes of explanation only and so as to not obscure the present disclosure with details that are well known to those skilled in the art. Nevertheless, the attached drawings are included to describe and explain illustrative examples of the present disclosure. The words and phrases used herein should be understood and interpreted to have a meaning consistent with the understanding of those words and phrases by those skilled in the relevant art. No special definition of a term or phrase, i.e., a definition that is different from the ordinary and customary meaning as understood by those skilled in the art, is intended to be implied by consistent usage of the term or phrase herein. To the extent that a term or phrase is intended to have a special meaning, i.e., a meaning other than that understood by skilled artisans, such a special definition will be expressly set forth in the specification in a definitional manner that directly and unequivocally provides the special definition for the term or phrase.

The present disclosure generally relates to various document driven methods for managing the content of databases that contain information related to semiconductor manufacturing operations. The methods and systems disclosed herein may be employed in manufacturing a variety of different integrated circuit products, e.g., memory devices, logic devices, ASICs, etc. With reference to the attached figures, various illustrative embodiments of the methods and system disclosed herein will now be described in more detail.

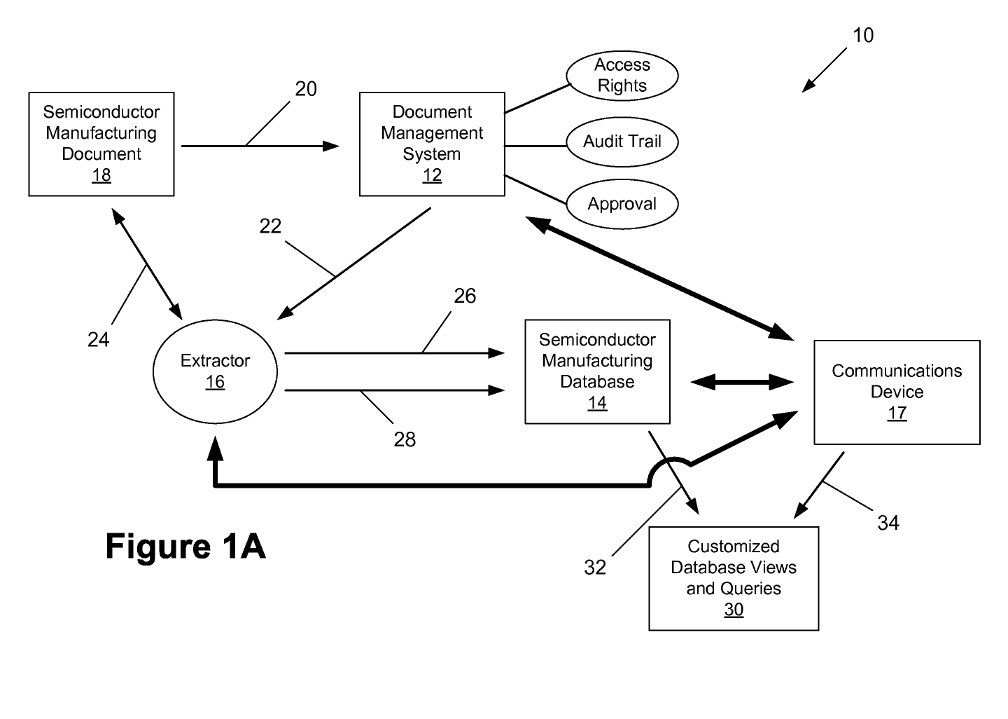

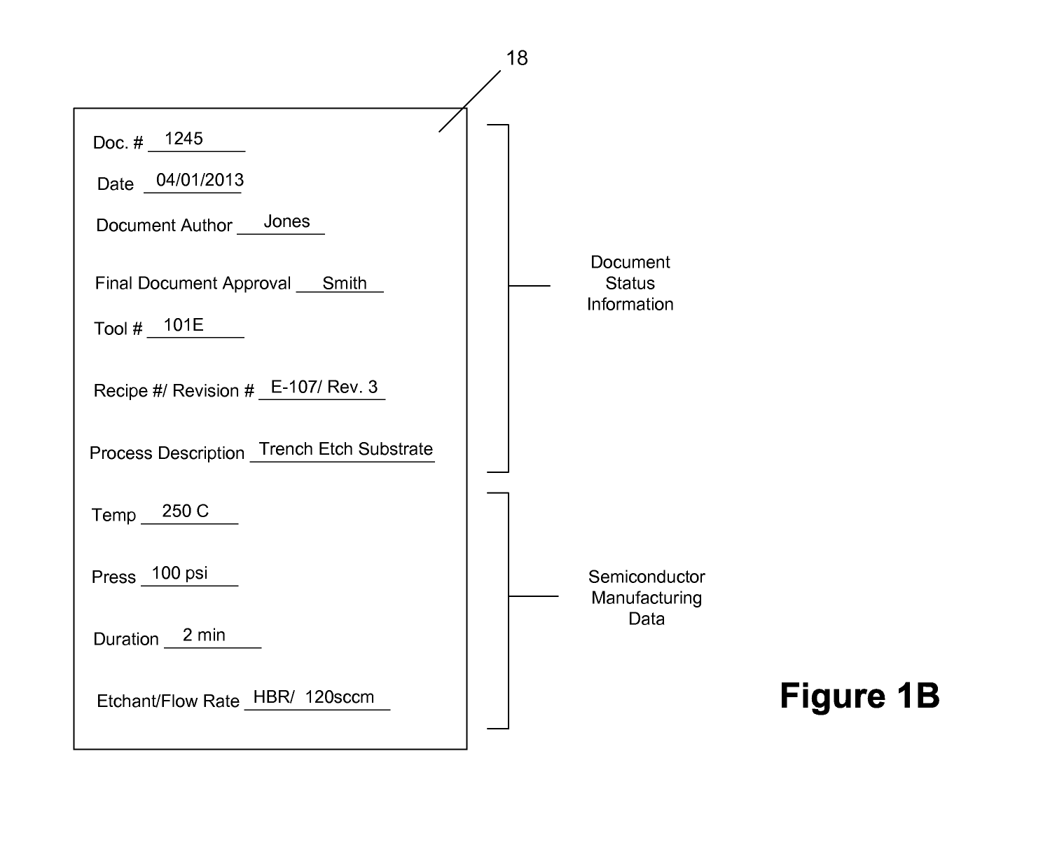

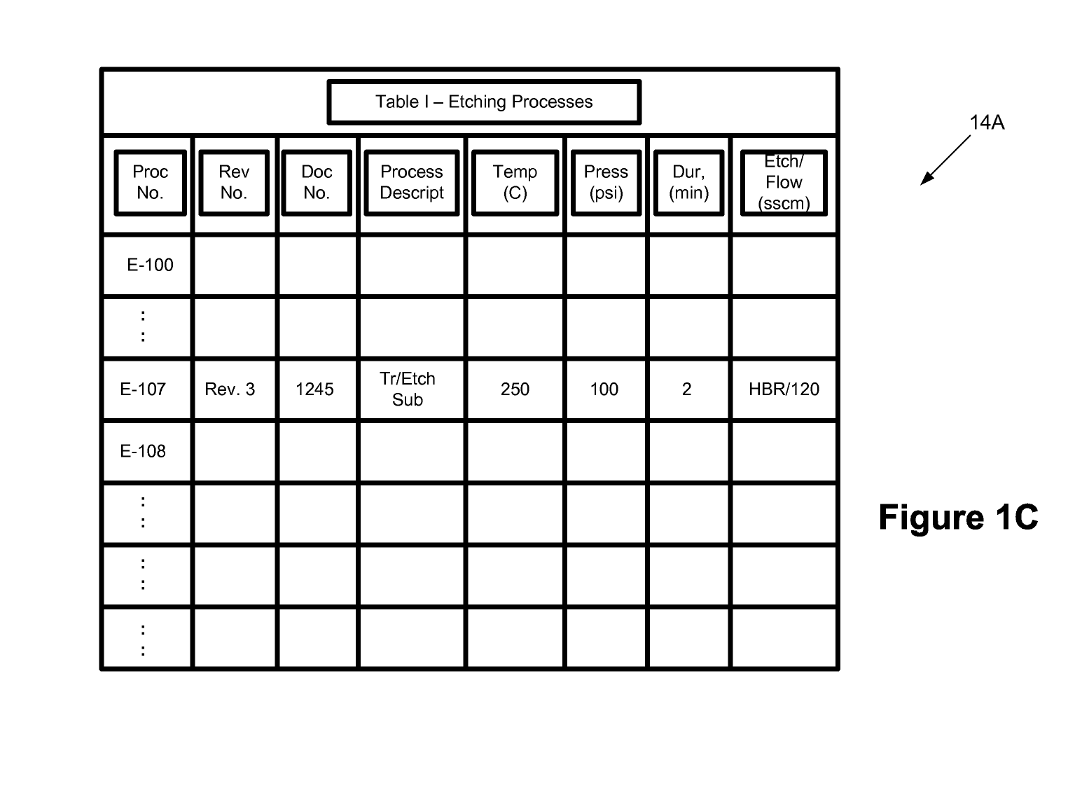

FIG. 1A schematically illustrates an illustrative system 10 disclosed herein for managing the content of data contained in a database that contains semiconductor manufacturing data. In the depicted example, the system 10 is comprised of a document management system (DMS) 12, a semiconductor manufacturing database (SMD) 14 and an extractor 16. A user (not shown) with the appropriate access rights may access any portion of the system 10 (as indicated by the bold double arrowed lines) by use of any type of communications device 17, e.g., a computer, a wireless hand-held device, etc., via a private network, a telephone system or via the Internet. Also depicted in FIG. 1A is an illustrative semiconductor manufacturing document 18 that contains semiconductor manufacturing data. In general, the semiconductor manufacturing document 18 is a document that is in human-readable form, e.g., a Word document, a pdf document, an xml document, etc., that may be accessed, created, modified and/or maintained by one or more personnel that the semiconductor manufacturer deems appropriate, such as a manufacturing/design engineer located at a semiconductor manufacturing facility, a design engineer located at an integrated circuit design facility, a client representative, etc.

As will be appreciated by those skilled in the art after a complete reading of the present application, the methods and systems disclosed herein have broad application as it relates to the manufacturing of integrated circuit devices. Thus, as used in this specification and in the attached claims, the phrase “semiconductor manufacturing data” should be understood to refer to any type of process-related data that may be employed by any type of processing tool used in manufacturing integrated circuit devices. For example, semiconductor manufacturing data includes, but is not limited to, information about operation description, process control limits, recipes, process flows, tool dedication, maintenance issues, scheduling of work flow, availability of manufacturing tools or equipment, etc. By way of example only, semiconductor manufacturing data may include data relating to basic processing operations, such as etching processes, deposition processes, photolithography processes, ion implantation processes, planarization processes, heating processes, etc., that are commonly performed when manufacturing integrated circuit products, as well as process flow tuning parameters, process control limits, product definitions, tool-to-product dedications, tool production release information, maintenance information, etc. For example, such semiconductor manufacturing data may be a process temperature, a process pressure, a process duration, the identification of one or more processing chemicals or materials used during a process operation, the identification of one or more gas flow rates or gas compositions used in a process operation, ion implantation angles, species, doses and/or energy levels used in an ion implantation process, a rotational speed of a polishing table in a CMP process operation, a polishing down-force in a CMP process operation, plating currents used in copper plating operations, electrical power settings, electrical current settings, target materials for use in a physical vapor deposition process, etc. Thus, the presently disclosed inventions should not be considered to be limited to use with any particular type or form of semiconductor manufacturing data.

With continuing reference to FIG. 1A, the semiconductor manufacturing document 18 may be stored in the document management system (DMS) 12, as indicated by the arrow 20. The document management system (DMS) 12 may be any type of system that allows creation and modification of documents by a user (not shown) that is allowed access to the document management system (DMS) 12. In one example, the document management system (DMS) 12 may be a file-based document management system such as Microsoft SharePoint, Documentum, Alfresco, Oracle PLM, etc., or even a change management system like Subversion, Rational ClearCase, Microsoft Visual Source Safe, or a self-written document management system, etc. The document management system (DMS) 12 should provide a robust array of functionality that may be used in storing, modifying, creating and accessing various semiconductor manufacturing documents 18. For example, as depicted in FIG. 1A, the document management system (DMS) 12 should have the capability of limiting access rights, means for establishing and maintaining an auditable trail of the revisions made to the semiconductor manufacturing documents 18, i.e., versioning history, and a means of approving the semiconductor manufacturing documents 18 stored in the document management system (DMS) 12 by one or more personnel or departments within the semiconductor manufacturing facility. As more specific examples, in some cases, the document management system (DMS) 12 should provide redlining capability, the ability to track authors or editors of the semiconductor manufacturing documents 18, and the ability to track when such documents were created, accessed, approved or modified, and identify the person who performed such actions. The document management system (DMS) 12 should also have the capability of storing the semiconductor manufacturing documents 18 in any desired manner, e.g., by categorizing or associating the files to a particular category of processes (e.g., folder structure, keywords, search criteria), e.g., etching processes, to a particular process tool, e.g., etch tool “A”, or by a specific process operation, e.g., etching a trench in a substrate, etc. The document management system (DMS) 12 should also have the capability of readily showing changes in version of documents, e.g., by highlighting changes between different versions of the document and identifying the person that made the changes to the initial document.

The semiconductor manufacturing database (SMD) 14 may be any type of system that is capable of storing semiconductor manufacturing data for use by various manufacturing execution and control systems used in manufacturing integrated circuit products. The semiconductor manufacturing database (SMD) 14 is the source of trust for data that is to be communicated to the manufacturing execution system (MES) and the various control systems that are employed to manage and control the processing tools used in the semiconductor manufacturing facility using standardized communication protocols. In one example, the semiconductor manufacturing data that is part of a process recipe may be downloaded from the semiconductor manufacturing database (SMD) 14 to a processing tool so that the processing tool can perform a process operation on one or more semiconductor substrates using the parameters in the downloaded process recipe. Alternatively, the process tool may communicate with the semiconductor manufacturing database (SMD) 14 to confirm that a process recipe stored locally on or near the processing tool is, in fact, the latest approved version of the process recipe prior to actually performing the locally stored process recipe on a substrate. The semiconductor manufacturing database (SMD) 14 should also have the capability to produce customized views and allow queries for information contained in the semiconductor manufacturing database (SMD) 14, as reflected in block 30. Examples of such customized views include, but are not limited to, views of all recipes needed to manufacture a specific product, views of all needed process steps involved in manufacturing a specific product, etc. Examples of such customized queries include, but are not limited to, specific queries to search for recipes using parameters within a certain range. In one illustrative example, the semiconductor manufacturing database (SMD) 14 may be an Oracle RDBMS, IBM DB2, Microsoft SQL Server, MySql (Oracle), IBM SiView DB, Applied Materials Fab300 DB, etc., or a self-written database system. In one particular example, the SMD 14 may be a live replicate of IBM SiView DB hosted on Oracle RDBMS. These customized views and queries may be created by or accessed via the communications device, as reflected by the arrowed line 34 in FIG. 1A.

FIG. 1B depicts a very simplistic example of an illustrative semiconductor manufacturing document 18 for purposes of explaining various aspects of the inventions disclosed herein. The semiconductor manufacturing document 18 may be stored and used in the system 10. In this example, the semiconductor manufacturing document 18 is a process recipe for performing an etching process to define a trench in a semiconductor substrate. The semiconductor manufacturing document 18 will typically include numerous fields of information, the amount of which may vary depending upon the particular process operation that is the subject matter of the semiconductor manufacturing document 18. For example, the semiconductor manufacturing document 18 may contain one or more of the following items directed to document status information: a unique document identification number (“Doc. #”); the date (“Date”) the document was created or modified; one or more fields (“Final Document Approval”) directed to when the newly-created or modified document was approved for release to manufacturing operations approval; an identification of a particular processing tool (“Tool #) on which the particular processing recipe is to be run; a unique recipe number (“Recipe #”) and document revision number (“Revision #”); and a brief process description (“Process Description”). The document status information may also include document metadata like the author, the document owner/department, etc. The semiconductor manufacturing document 18 may also contain one or more of the following items directed to semiconductor manufacturing data: temperature (“Temp”); pressure (“Press”); process duration (“Duration”); and etchants used during the etching process and the flow rates of such etchants (“Etchant/Flow Rate”).

Typically, the semiconductor manufacturing database (SMD) 14 will contain a number of tables where at least some semiconductor manufacturing data will be stored for use by the manufacturing execution and control systems in the semiconductor manufacturing facility. The tables may take a variety of forms and contain a variety of different information. For example, in some cases, the semiconductor manufacturing database (SMD) 14 may contain one or more tables that contain the semiconductor manufacturing data, i.e., the process recipes, for a single type of processing activity, such as etching recipes, deposition recipes, ion implantation recipes, etc. In other situations, the semiconductor manufacturing database (SMD) 14 may contain a table listing each unique process operation to be performed, e.g., etch trench in substrate, deposition of gate polysilicon, extension implant process, etc. Thus, the manner and form in which the tables of data are created, arranged or configured within the semiconductor manufacturing database (SMD) 14 should not be considered to be a limitation of the presently disclosed invention.

FIG. 1C depicts a simplistic example of an illustrative table 14A that may be contained within the semiconductor manufacturing database (SMD) 14. In this example, the table 14A is a collection of semiconductor manufacturing data for several etching recipes that may be employed in manufacturing integrated circuit products. In the depicted embodiment, certain of the information in the semiconductor manufacturing document 18 regarding etching process “E-107” has been transferred to the table 14A. As noted earlier, some or all of the information in the table 14A may be transmitted to an etching tool so as to enable the etching tool to perform the subject etching process, e.g., etching process E-107.

In one illustrative embodiment, some or all of the information contained in the semiconductor manufacturing document 18 may be transmitted to the table 14A by use of the illustrative software-based extractor tool 16 that is schematically depicted in FIG. 1A. The extractor tool 16 may run on the same computer system that contains the system 10, or it may operate on a stand-alone computer system. The structure, function and operation of such extractor tools 16 are well known to those skilled in the art. In one illustrative embodiment, the extractor tool 16 may be a self-written application or any commercially available tool which has the capability, when properly configured and programmed, to extract the desired data out of the semiconductor manufacturing document 18. The semiconductor manufacturing document 18 and the table 14A are formatted and configured such that a certain piece of information from the semiconductor manufacturing document 18 can be positioned at the desired location within the table 14A.

With continuing reference to FIG. 1A, further illustrative aspects of the inventions disclosed herein will now be discussed. In one example, a user (not shown) may log-in to the system 10 (using a password) via an illustrative communications device, such as a computer, over an internal communications network within the semiconductor manufacturing facility. The system 10 is configured such that each user allowed access to the system 10 has certain rights. In some cases, a user may have only access or viewing rights, while, in other cases, senior personnel may be able to perform any or all activities that can be performed by the system 10, e.g., create, edit or delete semiconductor manufacturing documents 18, approve the content of such documents, upload the information in the semiconductor manufacturing document 18 to such an item of information in one or more of the semiconductor manufacturing documents 18 to a table in the semiconductor manufacturing database (SMD) 14, etc. Thus, the system 10 provides great flexibility, accountability and security as it relates the information contained in the document management system (DMS) 12 and/or the semiconductor manufacturing database (SMD) 14.

As indicated by the arrow 20, semiconductor manufacturing documents 18, in whatever form or degree of completion, may be stored in the document management system (DMS) 12. Users with appropriate rights may modify or edit a semiconductor manufacturing document 18 and post it for review by other personnel or departments that have access to the system 10 and need to approve or review any new semiconductor manufacturing document 18 or any modified semiconductor manufacturing document 18. As an example, if an etching process is revised so as to increase the depth of a trench in a substrate, other departments such as deposition, lithography and/or CMP may need to review and approve the modified semiconductor manufacturing document 18 prior to it being released to manufacturing for use in manufacturing real-world integrated circuit products. As indicted previously, using the document management system (DMS) 12 disclosed herein, users may access prior versions of the semiconductor manufacturing document 18 that may have been stored in the document management system (DMS) 12, identify prior personnel who previously made changes to the semiconductor manufacturing document 18, and indicate, in redlined form, the proposed changes the user is proposing to make to the current version of the semiconductor manufacturing document 18. In one aspect, once the proposed changes are made, the user may then transmit the edited document, by email for example, to one or more personnel or departments for review-approval. Alternatively, the user may simply notify a pre-identified group of people or departments within the semiconductor manufacturing facility that a proposed change to semiconductor manufacturing document # XYZ, is now ready for review, comment and/or approval by the identified personnel.

At some point, the semiconductor manufacturing document 18 (either newly created or modified) will have been approved by all necessary personnel, and it may now be released for use in manufacturing integrated circuit products. As one specific example, after the semiconductor manufacturing document 18 (either newly created or modified) has received initial approval by all relevant personnel/departments, the user may create a “final” version of the semiconductor manufacturing document 18 for final review and final approval by all necessary personnel/departments. Approval of a new or modified semiconductor manufacturing document 18 may be indicated in the semiconductor manufacturing document 18 by any of a variety of techniques, e.g., checking a box, supplying a unique code used by the personnel/departments when approving such changes or documents, electronic signatures, etc.

At the point when the appropriate approvals have been obtained, such that the semiconductor manufacturing document 18 (either newly created or modified) is ready to be released to the manufacturing floor, some or all of the information in the approved semiconductor manufacturing document 18 (either newly created or modified) may be transferred to the appropriate table in the semiconductor manufacturing database (SMD) 14. In one illustrative example, when all of the necessary approvals have been obtained, the system 10 is actuated or triggered, as indicated by the arrow 22, to instruct the extractor tool 16 to extract at least some, if not all, of the information and/or semiconductor manufacturing data in the subject semiconductor manufacturing document 18 (either newly created or modified) and load that extracted information in an appropriate table in the semiconductor manufacturing database (SMD) 14. In some applications, the document management system (DMS) 12 may be used to actuate or trigger the extractor tool 16 by sending a signal to the extractor tool 16. Another implementation could be a polling approach. In such a situation, the application monitors the document management system (DMS) 12 and triggers the extractor tool 16 if changes are made to any document or to an identified subset of documents. Finally, even the document editor can trigger the extractor 16, as or after the document is submitted to the document management system (DMS) 12. The extraction of the information and/or semiconductor manufacturing data from the semiconductor manufacturing document 18 by use of the extractor tool 16 is schematically reflected by the double-arrowed line 24. The extractor tool 16 transmits the extracted information/data to the appropriate table(s) in the semiconductor manufacturing database (SMD) 14, as reflected by the arrowed lines 26, 28. In one illustrative example, the arrowed line 26 may be indicative of one or more items of semiconductor manufacturing data contained in the subject semiconductor manufacturing document 18, while the arrowed line 28 may be indicative of one or more items of document status information in the semiconductor manufacturing document 18, such as final approval, document number, etc.

As will be appreciated by those skilled in the art after a complete reading of the present application, the methods and systems disclosed herein provide a robust and effective means of managing semiconductor manufacturing data for use in a semiconductor manufacturing facility. Importantly, the methods disclosed herein may be employed without the use and creation of complex GUIs as is common with prior art systems. This will result in a reduction in manpower needed to implement the system 10 disclosed herein as compared to the prior art, GUI intensive systems discussed in the background section of this application. Moreover, the presently disclosed system provides a user-friendly environment in which to create or modify semiconductor manufacturing documents 18, and to obtain approval thereof, in a way that may be readily tracked and audited.

As is evident from the discussion above, some features or aspects of the subject matter disclosed herein may be implemented in software. For instance, some or all of the various acts described above may be software-implemented, in whole or in part. Thus, some features or acts of the presently disclosed inventions may be implemented as instructions encoded on a computer-readable, program storage medium. The program storage medium may be of any type suitable to the particular implementation. However, the program storage medium will typically be magnetic, such as the floppy disk, a computer, a hard disk drive, an optical disk, etc. When these instructions are executed by a computer, they perform the disclosed functions. The computer may be a desktop computer or, alternatively, the computer may be an embedded processor. The computer might also be a laptop, a workstation or a mainframe in various other embodiments. Thus, the scope of the invention should not be considered to be limited by the type or nature of the program storage medium or computer with which embodiments of the invention might be implemented.

Thus, some portions of the detailed descriptions herein are, or may be, presented in terms of algorithms, functions, techniques and/or processes. These terms enable those skilled in the art most effectively to convey the substance of their work to others skilled in the art. These terms are here, and are generally, conceived to be a self-consistent sequence of steps leading to a desired result. The steps are those requiring physical manipulations of physical quantities. Usually, though not necessarily, these quantities take the form of electromagnetic signals capable of being stored, transferred, combined, compared and otherwise manipulated.

It has proven convenient at times, principally for reasons of common usage, to refer to these signals as bits, values, elements, symbols, characters, terms, numbers and the like. All of these and similar terms are to be associated with the appropriate physical quantities and are merely convenient labels applied to these quantities and actions. Unless specifically stated otherwise, or as may be apparent from the discussion, terms such as “processing,” “computing,” “calculating,” “determining,” “displaying” and the like used herein refer to the action(s) and processes of a computer system, or similar electronic and/or mechanical computing device, that manipulates and transforms data, represented as physical (electromagnetic) quantities within the computer system's registers and/or memories, into other data similarly represented as physical quantities within the computer system's memories and/or registers and/or other such information storage, transmission and/or display devices.

The particular embodiments disclosed above are illustrative only, as the invention may be modified and practiced in different but equivalent manners apparent to those skilled in the art having the benefit of the teachings herein. For example, the process steps set forth above may be performed in a different order. Furthermore, no limitations are intended to the details of construction or design herein shown, other than as described in the claims below. It is therefore evident that the particular embodiments disclosed above may be altered or modified and all such variations are considered within the scope and spirit of the invention. Accordingly, the protection sought herein is as set forth in the claims below.

What is claimed:

1. A method of using a system comprised of a document management system, a semiconductor manufacturing database and an extractor tool, the method comprising:
storing a semiconductor manufacturing document in said document management system, said semiconductor manufacturing document comprising semiconductor manufacturing data; and
actuating said extractor tool to:
extract at least a portion of said semiconductor manufacturing data from said semiconductor manufacturing document; and
transfer said extracted semiconductor manufacturing data to at least one table in said semiconductor manufacturing database.

2. The method of claim 1, wherein, prior to actuating said extractor tool, the method comprises determining a final approval of said semiconductor manufacturing document has been obtained.

3. The method of claim 1, wherein said semiconductor manufacturing document is one of a newly-created semiconductor manufacturing document or a revised version of a previously-created semiconductor manufacturing document.

4. The method of claim 1, wherein said semiconductor manufacturing data comprises at least one parameter of a process operation to be performed by a process tool in manufacturing an integrated circuit product.

5. The method of claim 1, wherein said document management system, said semiconductor manufacturing database and said extractor tool are contained in a single computer system.

6. The method of claim 1, wherein, prior to actuating said extractor tool, the method comprises:
conducting a polling operation of semiconductor manufacturing documents located within said document management system;
determining if a change has been made to any such semiconductor manufacturing documents; and
actuating said extractor tool in response to a determination that at least one semiconductor manufacturing document in said document management system has been changed.

7. A method of using a system comprised of a document management system, a semiconductor manufacturing database and an extractor tool, the method comprising:
storing a semiconductor manufacturing document in said document management system, said semiconductor manufacturing document comprising semiconductor manufacturing data;
using said document management system to obtain a final approval for said semiconductor manufacturing document; and
after obtaining said final approval, actuating said extractor tool to:
extract at least a portion of said semiconductor manufacturing data from said semiconductor manufacturing document; and
transfer said extracted semiconductor manufacturing data to at least one table in said semiconductor manufacturing database.

8. The method of claim 7, wherein said semiconductor manufacturing document is one of a newly-created semiconductor manufacturing document or a revised version of a previously-created semiconductor manufacturing document.

9. The method of claim 7, wherein said semiconductor manufacturing data comprises at least one parameter of a process operation to be performed by a process tool in manufacturing an integrated circuit product.

10. A method of using a system comprised of a document management system, a semiconductor manufacturing database and an extractor tool, the method comprising:
storing a plurality of semiconductor manufacturing documents in said document management system, each of said semiconductor manufacturing documents comprising semiconductor manufacturing data;
conducting a polling operation of said plurality of semiconductor manufacturing documents located within said document management system;
determining if a change has been made to any semiconductor manufacturing data on any of said plurality of semiconductor manufacturing documents; and
upon detecting a change to the semiconductor manufacturing data in at least one of said plurality of semiconductor manufacturing documents, actuating said extractor tool to:
extract at least a portion of said semiconductor manufacturing data from said semiconductor manufacturing document where said semiconductor manufacturing data was changed; and
transfer at least said extracted semiconductor manufacturing data to at least one table in said semiconductor manufacturing database.

11. The method of claim 10, wherein, prior to actuating said extractor tool, the method comprises determining a final approval of said semiconductor manufacturing document has been obtained.

12. The method of claim 10, wherein said semiconductor manufacturing document is one of a newly-created semiconductor manufacturing document or a revised version of a previously-created semiconductor manufacturing document.

13. The method of claim 10, wherein said semiconductor manufacturing data comprises at least one parameter of a process operation to be performed by a process tool in manufacturing an integrated circuit product.

14. The method of claim 10, wherein said document management system, said semiconductor manufacturing database and said extractor tool are contained in a single computer system.
